(19) United States
(12) Patent Application Publication
(10) Pub. No.: US 2013/0286644 A1
(43) Pub. Date: Oct. 31, 2013

(54) LED LIGHT BAR WITH BALANCED RESISTANCE FOR LIGHT EMTITTING DIODES THEREOF

(71) Applicant: CHIH-CHEN LAI, Tu-Cheng (TW)

(72) Inventor: CHIH-CHEN LAI, Tu-Cheng (TW)

(73) Assignee: HON HAI PRECISION INDUSTRY CO., LTD., Tu-Cheng (TW)

(21) Appl. No.: 13/563,738

(22) Filed: Aug. 1, 2012

(30) Foreign Application Priority Data
Apr. 25, 2012 (TW) 101114683

(51) Int. Cl. F21V 21/00

(52) U.S. Cl. 362/217.14

(57) ABSTRACT

An LED light bar includes LED chips and a printed circuit board. A number of welding pads are disposed on the printed circuit board, and correspondingly connected to anodes and cathodes of the LED chips respectively. The welding pads connected to the anodes of the LED chips are connected by wire lines for connecting an anode of an electrical power source. The welding pads connected to the cathodes of the LED chips are connected by the wire lines for connecting a cathode of the electrical power source. The resistance of the wire lines connected to the LED chips increases from one near the electrical power source to the one far from the electrical power source. The resistance of the welding pads connected to the LED chips decreases from one near the electrical power source to the one far from the electrical power source.

### BACKGROUND

1. Technical Field

The present disclosure relates to light emitting diode (LED) light sources, and particularly to an LED light bar with balanced resistance for LEDs thereof, whereby current from the power source can be evenly distributed to the LEDs.

2. Description of Related Art

Referring to FIG. 1, a conventional LED light bar 10 includes a printed circuit board (PCB) 11, four LED chips 12, four pairs of welding pads 16, and four pairs of wire lines 13. The four pairs of welding pads 16 are disposed on the printed circuit board 11 at intervals, and correspondingly connected to anodes and cathodes of the LED chips 12 respectively. Each pair of the wire lines 13 includes two first ends correspondingly connected to one pair of welding pads 16 respectively and two second ends respectively connected to an anode and a cathode of an electrical power source 14. The longer the length of the wire line 13 is, the larger the resistance of the wire line 13 is. The welding pads 16 have the same resistance, since they have the same size. Since the wire lines 13 connected between the electrical power source 14 and the welding pads 16 have different lengths, the working current flowing through the different LED chips 12 are different from each other and unevenly distributed among the LED chips 12, whereby the LED chip 12 which is nearest to the electrical power source is easier to be broken down since it has more current flowing therethrough and thus generates more heat than other LED chips 12. It is preferable that the LED chips 12 have the same usable life.

It is thus desirable to provide an LED light bar which can overcome the limitations described.

### BRIEF DESCRIPTION OF THE DRAWINGS

FIG. 1 is a schematic view of an LED light bar in accordance with related art.

FIG. 2 is a schematic view of an LED light bar in accordance with a first embodiment of the present disclosure.

FIGS. 3-4 are schematic views showing manufacturing process of welding pads of the LED light bar of FIG. 2.

FIG. 5 is a schematic view of an LED light bar in accordance with a second embodiment of the present disclosure.

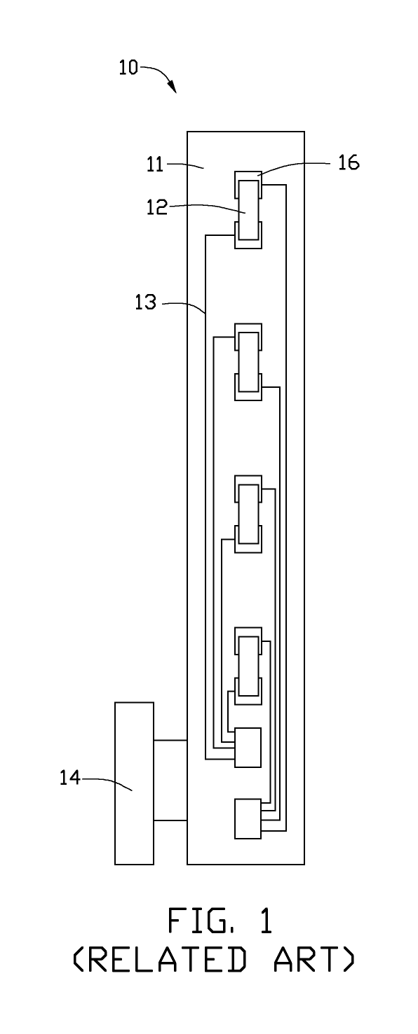

### DETAILED DESCRIPTION

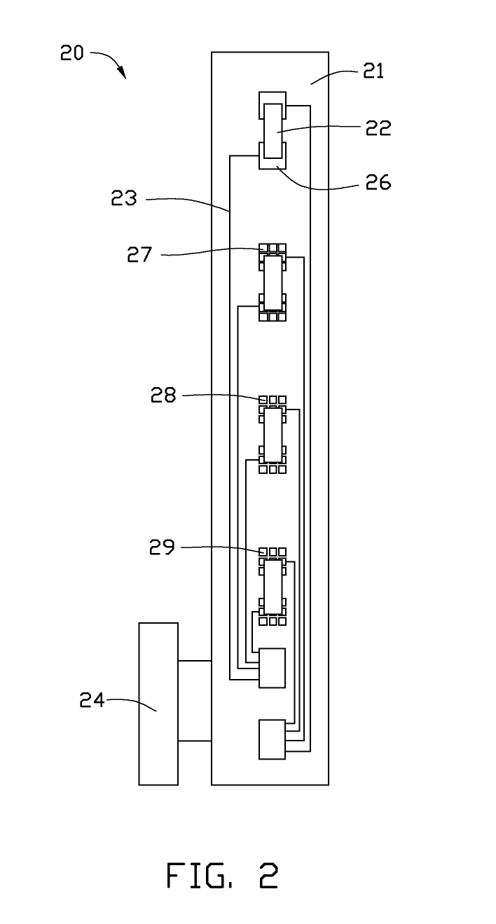

Referring to FIG. 2, an LED light bar 20 according to a first embodiment of the disclosure includes a printed circuit board (PCB) 21, four LED chips 22, four pairs of welding pads 26, 27, 28, 29, and four pairs of wire lines 23. The four pairs of welding pads 26, 27, 28, 29 are disposed on the printed circuit board 21 at intervals, and correspondingly connected to anodes and cathodes of the LED chips 22 respectively. Each pair of wire lines 23 include two first ends correspondingly connected to one pair of welding pads 26, 27, 28, 29 respectively and two second ends respectively connected to an anode and a cathode of an electrical power source 24.

The wire lines 23 connected between the electrical power source 24 and the welding pads 26, 27, 28, 29 have lengths different from each other. The longer the length of the wire line 23 is, the larger the resistance of the wire line 23 is. That is, the resistance of the wire line 23 is in proportion to the length of the wire line 23. In detail, r1 represents the resistance of the pair of wire lines 23 connecting the pair of welding pads 29 with the electrical power source 24; r2 represents the resistance of the pair of wire lines 23 connecting the pair of welding pads 28 with the electrical power source 24; r3 represents the resistance of the pair of wire lines 23 connecting the pair of welding pads 27 with the electrical power source 24; and r4 represents the resistance of the pair of wire lines 23 connecting the pair of welding pads 26 with the electrical power source 24. The relation among r1, r2, r3 and r4 meets following inequality: r1<r2<r3<r4.

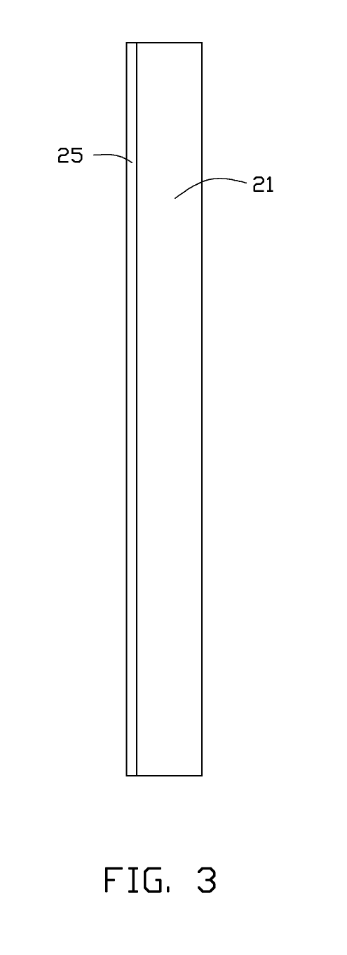

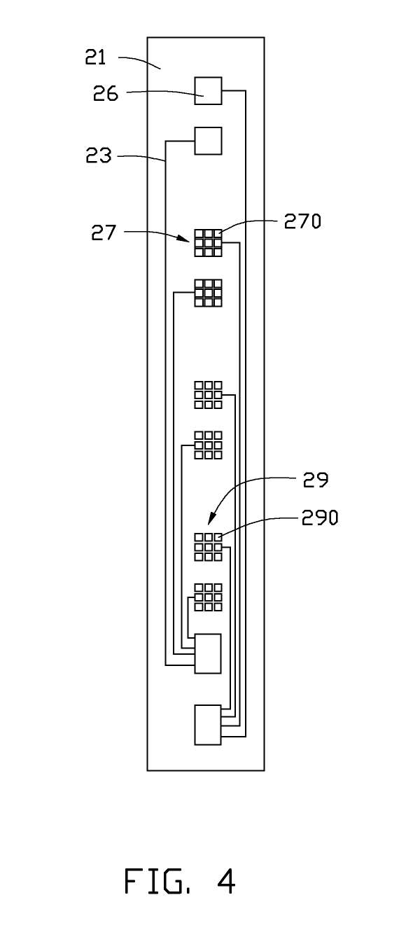

Referring to FIGS. 3-4, the welding pads 26, 27, 28, 29 disposed on the printed circuit board 21 are formed by following steps: firstly, forming a metal layer 25 (such as a copper layer) on the printed circuit board 21; then etching the metal layer 25 to form the welding pads 26, 27, 28, 29 and simultaneously form the wire lines 23.

Referring to FIG. 4, the configuration of each welding pad 26, 27, 28, 29 is shown, which is rectangular. Each welding pad 26, 27, 28, 29 has the same width and length as another. In other words, an area delimited by each welding pad 26, 27, 28, 29 is the same as each other. However, the real estates they have are different from each other. Each of the welding pads 27, 28, 29 is divided into nine welding pad units 270, 280, 290. The welding pad units 270, 280, 290 of each welding pad 27, 28, 29 are spaced one from another with a certain interval, wherein the interval between the welding pad units 290 is larger than that between the welding pad units 280 which in turn is larger than that between the welding pad units 270. Meanwhile the welding pads 26 each is a one-piece pad. Thus, real estates (actual areas) a1, a2, a3, a4 that the welding pads 26, 27, 28, 29 occupy are gradually decreased in that sequence. In other words, the relation among a1, a2, a3, a4 satisfies the inequality: a1>a2>a3>a4. The resistance of each welding pad 26, 27, 28, 29 is in an inverse proportion to the actual area of each welding pad 26, 27, 28, 29. Thus, compared with the resistance of the welding pad 26 which is not divided into welding pad units, the resistance of each welding pad 27, 28, 29 increases after being divided into welding pad units 270, 280, 290.

The intervals of the welding pad units 270, 280, 290 of the welding pads 27, 28, 29 decrease from the pair of welding pads 29 near the electrical power source 24 to the pair of welding pads 27 far from the electrical power source 24. That is, the interval of the welding pad units 270 of each welding pad 27 is smaller than that of the welding pad units 280 of each welding pad 28; the interval of the welding pad units 280 of each welding pad 28 is smaller than that of the welding pad units 290 of each welding pad 29. Therefore, the actual areas of the welding pads 27, 28, 29 increase from the pair of welding pads 29 near the electrical power source 24 to the pair of welding pads 27 far from the electrical power source 24. The resistances of the welding pads 27, 28, 29 decrease from the pair of welding pads 29 near the electrical power source 24 to the pair of welding pads 27 far from the electrical power source 24. Since the pair of welding pads 26 farthest from the electrical power source 24 are not divided into welding pad units, each welding pad 26 has the delimited area the same as its actual area, and the resistance of each welding pad 26 is the smallest when compared with that of each of the welding pads 27, 28, 29.

In detail, R1 represents the resistance of the pair of welding pads 29; R2 represents the resistance of the pair of welding pads 28; R3 represents the resistance of the pair of welding pads 27; and R4 represents the resistance of the pair of welding pads 26. The relation among R1, R2, R3 and R4 meets following inequality: R1>R2>R3>R4. The resistances r1, r2, r3, r4 of the wire lines 23 and the resistances R1, R2, R3, R4 of the welding pads 26, 27, 28, 29 meet following equalities: r1+R1=r2+R2=r3+R3=r4+R4.

According to the disclosure, the resistances of the wire lines 23 increase from the welding pad 29 near the electrical power source 24 to the welding pad 26 far from the electrical power source 24. The resistances of the welding pad 26, 27, 28, 29 gradually decrease from the pair of welding pads 29 near the electrical power source 24 to the pair of welding pads 26 far from the electrical power source 24. A total resistance of one pair of the welding pads 26, 27, 28, 29 and the wire lines 23 which are connected to the corresponding one of the LED chips 22 is the same as a total resistance of another pair of the welding pads 26, 27, 28, 29 and the wire lines 23 which are connected to the corresponding another one of the LED chips 22. That is, the resistance between each LED chip 22 and the electrical power source 24 is the same as another and balanced. The working current flowing through each LED chip 22 is thus the same as another. Therefore, the working current can be evenly distributed among the LED chips 22, whereby the LED chips 22 can have a uniform life of use.

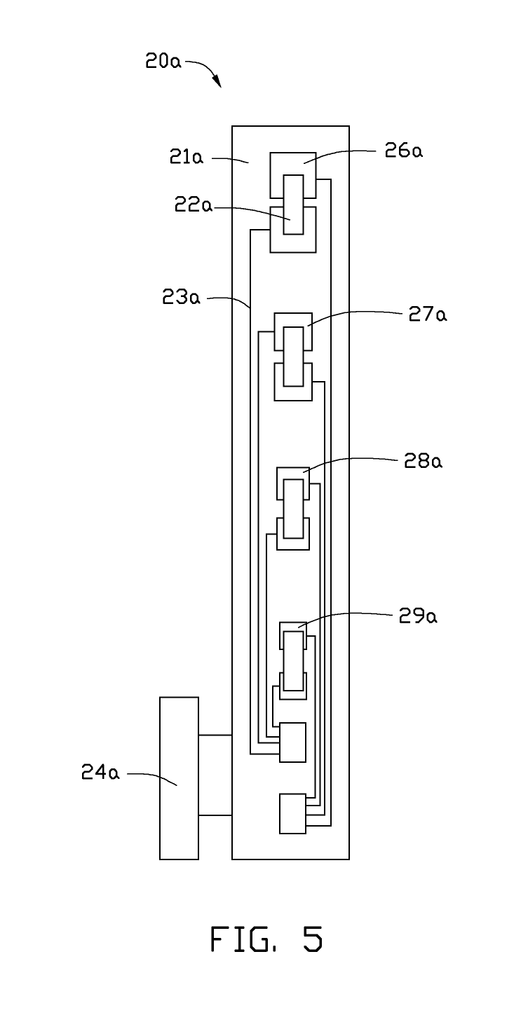

Referring to FIG. 5, an LED light bar 20a according to a second embodiment of the disclosure includes a printed circuit board (PCB) 21a, four LED chips 22a, four pairs of welding pads 26a, 27a, 28a, 29a, and four pairs of wire lines 23a. The four pairs of welding pads 26a, 27a, 28a, 29a are disposed on the printed circuit board 21a at intervals, and correspondingly connected to anodes and cathodes of the LED chips 22a respectively. Each pair of wire lines 23a includes two first ends correspondingly connected to one pair of welding pads 26a, 27a, 28a, 29a respectively and two second ends respectively connected to an anode and a cathode of an electrical power source 24a.

Differences between the LED light bar 20a of the second embodiment and LED light bar 20 of the first embodiment are in that: the welding pads 26a, 27a, 28a, 29a each are not divided into welding pad units, each welding pad 26a, 27a, 28a, 29a is a one-piece pad. However, the widths and lengths of the welding pads 26a, 27a, 28a, 29a are different from each other. The welding pads 26a, 27a, 28a, 29a have actual areas gradually increased from one pair near the electrical power source 24a to another pair far from the electrical power source 24a. The welding pads 26a, 27a, 28a, 29a have resistances gradually decreased from one pair near the electrical power source 24a to another pair far from the electrical power source 24a. A total resistance of the welding pads 26a, 27a, 28a, 29a and the wire lines 23a which are connected to the one LED chip 22a is the same as a total resistance of the welding pads 26a, 27a, 28a, 29a and the wire lines 23a which are connected to another LED chip 22a. That is, the resistance between each LED chip 22a and the electrical power source 24a is also the same as another.

It is to be understood, however, that even though numerous characteristics and advantages of the disclosure have been set forth in the foregoing description, together with details of the structure and function of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An LED light bar, comprising:
a plurality of LED chips, each LED chip comprising an anodes and a cathode;
a printed circuit board;
a plurality of welding pads disposed on the printed circuit board, the plurality of welding pads comprising a first group of welding pads correspondingly connected to the anodes of the plurality of LED chips respectively and a second group of welding pads correspondingly connected to the cathodes of the plurality of LED chips respectively; and
a plurality of wire lines comprising a first group of wire lines and a second group of wire lines, the first group of wire lines comprising first ends correspondingly connected to the first group of welding pads respectively and second ends adapted for being connected to an anode of an electrical power source, the second group of wire lines comprising first ends correspondingly connected to the second group of welding pads respectively and second ends adapted for being connected to a cathode of the electrical power source;
wherein the resistances of the plurality of wire lines gradually increase from the welding pad near the electrical power source to the welding pad far from the electrical power source, and the resistances of the plurality of welding pads gradually decrease from the welding pad near the electrical power source to the welding pad far from the electrical power source.

2. The LED light bar of claim 1, wherein a total resistance of one pair of the welding pads and the wire lines which are connected to a corresponding one of the LED chips is the same as a total resistance of another pair of the welding pads and the wire lines which are connected to a corresponding another one of the LED chips.

3. The LED light bar of claim 2, wherein each welding pad is divided into a plurality of welding pad units, the welding pad units of each welding pad being spaced one from another with a certain interval, each of the welding pads having the same delimited area as another, the intervals of the welding pad units of the welding pads decreasing from the welding pad near the electrical power source to the welding pad far from the electrical power source, whereby the actual areas of the welding pads increase from the welding pad near the electrical source to the welding pad far from the electrical power source.

4. The LED light bar of claim 2, wherein each welding pad is a one-piece pad, the areas of the welding pads increasing from the welding pad near the electrical power source to the welding pad far from the electrical power source.

5. The LED light bar of claim 1, wherein the welding pads are formed by etching a metal layer disposed on the printed circuit board.

6. An LED light bar, comprising:
a plurality of LED chips, each LED chip comprising an anodes and a cathode;
a printed circuit board;
a plurality of pairs of welding pads disposed on the printed circuit board, each pair of welding pads being correspondingly connected to the anode and the cathode of one said LED chip; and
a plurality of pairs of wire lines, each pair of wire lines comprising two first ends correspondingly connected to one of the pairs of welding pads respectively and two second ends adapted for being connected to an anode and a cathode of an electrical power source;
wherein the resistances of the pairs of wire lines gradually increase from the pair of welding pads near the electrical power source to the pair of welding pads far from the electrical power source, and the actual areas of the pairs of welding pads increase from the pair of welding pads near the electrical power source to the pair of welding pads far from the electrical power source, the resistance of each welding pad being in an inverse proportion to the actual area of each welding pad.

7. The LED light bar of claim 6, wherein a total resistance of one pair of the welding pads and the wire lines which are connected to a corresponding one of the LED chips is the same as a total resistance of another pair of the welding pads and the wire lines which are connected to a corresponding another one of the LED chips.

8. The LED light bar of claim 7, wherein each welding pad is divided into a plurality of welding pad units, the welding pad units of each welding pad being spaced one from another with a certain interval, each of the welding pads having the same shape and delimited area as another, the intervals of the welding pad units of the welding pads decreasing from the pair of welding pads near the electrical power source to the pair of welding pads far from the electrical power source, whereby the actual areas of the pairs of welding pads increase from the pair of welding pads near the electrical power source to the pair of welding pads far from the electrical power source.

9. The LED light bar of claim 7, wherein each welding pad is one-piece pad.

10. The LED light bar of claim 6, wherein the welding pads are formed by etching a metal layer disposed on the printed circuit board.
